(19) United States
(12) Patent Application Publication
(10) Pub. No.: US 2023/0334082 A1
(43) Pub. Date: Oct. 19, 2023

(54) SYSTEM AND METHOD FOR PROVIDING ADDITIONAL INFORMATION BASED ON MULTIMEDIA CONTENT BEING VIEWED

(71) Applicant: DISH Network Technologies India Private Limited, Bangalore (IN)

(72) Inventors: Yatish Jayant Naik Raikar, Bangalore (IN); Soham Sahabhaumik, Bangalore (IN)

(21) Appl. No.: 18/336,682

(22) Filed: Jun. 16, 2023

Related U.S. Application Data
(63) Continuation of application No. 15/799,814, filed on Oct. 31, 2017.

(51) Int. Cl. G06F 16/435; H04N 21/472; G06F 16/74; G06F 16/9535; H04N 21/2668

(52) U.S. Cl. CPC G06F 16/437; G06F 16/748; G06F 16/9535; H04N 21/2668; H04N 21/47205; H04N 21/8405

(57) ABSTRACT

A distributed computing system for artificial intelligence in relating a second multimedia program content with a first multimedia program content based on a key reference. A user terminal is set up locally in a user’s environment to monitor a first multimedia program content consumed by the user. The user’s reaction to a portion of the first multimedia program content is detected by the user terminal. The relevant portion of the first multimedia program content is identified and parsed to obtain a reference portion. The reference portion is related to a second multimedia portion using database mapping and machine learning.

### TECHNICAL FIELD

The present disclosure relates generally to presenting multimedia contents to a viewer, and more particularly, to providing additional information about additional contents based on a current multimedia content provided to the viewer.

### BACKGROUND

### Description of the Related Art

Over the past several years, home-theater systems have greatly improved the presentation of content to viewers with respect to how viewers listen to and view content. This improvement has been aided by the number of content channels that are available to listen or watch at any given time, the quality of video and audio output devices, and the quality of the input signal carrying the content.

As a consequence, nowadays, users have plenty of avenues to choose from for consuming multimedia content. For example, users can watch contents on one of the hundreds of channels and movies being broadcast on a set-top-box (STB). Users can also use internet services to access multiple streaming services of multimedia contents. The contents to be consumed could be TV series or movies, either classic (e.g. M*A*S*H, The Godfather) or contemporary (e.g. Game of Thrones, Doctor Strange). It is not possible for the user to be aware of and be able to make knowledgeable choices to consume the available content that suit their tastes and needs.

### BRIEF SUMMARY

The disclosure is directed to a system and method for providing additional information of related multimedia content to a user to compliment a current multimedia content consumed by the user. When a user watches multimedia program content, e.g., a movie, the user may be interested in additional details about a portion of the content, e.g., a dialog quoted from another a character of another movie, a historical record mentioned in a sports game, a signature action of a famous figure mimicked in the current multimedia content, etc. The current disclosure provides a solution to these needs.

A user terminal, e.g., a set-top-box, may be set up locally in a user’s environment to monitor a first multimedia content consumed by the user. The user’s reaction to a portion of the multimedia content, either an active reaction like a voice command of “tell me more” or a passive reaction like a change of body position or a change in facial expression, may be detected by the user terminal as indicating that the user is interested in the portion of the content. Such portion of content may be identified as a portion of interest and sent by the user terminal to a server for processing.

At the server, the portion of interest may be parsed to obtain one or more reference portions. Each reference portion will then be mapped with a database of key references which are each set up as associated with one or more multimedia content. The mapping result will either directly associate the reference portion with a second multimedia content if the mapping yields satisfactory matching between the reference portion and a key reference or tentatively associate the reference portion with a second multimedia content, if no satisfactory matching is obtained. The tentative association between the reference portion and the second multimedia content will then be further enhanced by learning more about the reference portion by using learning data of the reference portion. Learning data of the reference portion includes information of second multimedia content presented to other users as associated with the reference portion and the user reactions to the presented second multimedia content.

The learning data will be dynamically updated and when a threshold has been met, such learning data may be used to update the database of the key references. For example, the reference portion may be set up as a new key reference associated with the second multimedia content after the learning data has collected more information.

These features, with other technological improvements that will become subsequently apparent, reside in the details of construction and operation as more fully described hereafter and claimed, reference being had to the accompanying drawings forming a part hereof.

### BRIEF DESCRIPTION OF THE SEVERAL VIEWS OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures do not describe every aspect of the teachings disclosed herein and do not limit the scope of the claims.

FIG. 1 illustrates an example system environment for providing additional information of related content to a user;

FIG. 2 illustrates an example distributed computing system for providing additional information of related content to a user;

FIG. 3 illustrates an example content monitor system;

FIG. 4 illustrates an example user terminal;

FIG. 5 illustrates an example information provider server;

FIG. 6 illustrates an example operation process;

FIG. 7 illustrates another example operation process; and

FIG. 8 illustrates an example operation process with a distributed computing scheme.

### DETAILED DESCRIPTION

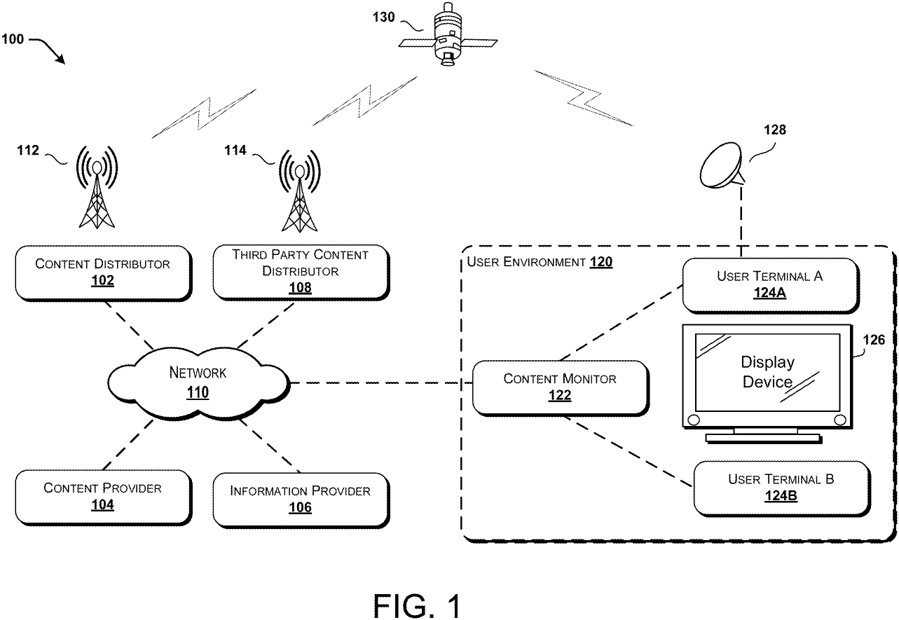

Each of the features and teachings disclosed herein may be utilized separately or in conjunction with other features and disclosure to provide a system and method for providing additional information of related contents based on a current multimedia content consumed by a user. Representative examples utilizing many of these additional features and teachings, both separately and in combination, are described in further detail with reference to the attached FIGS. 1-8. This detailed description is intended to teach a person of skill in the art further details for practicing aspects of the present disclosure and is not intended to limit the scope of the claims. Therefore, combinations of features disclosed above in the detailed description may not be necessary to practice the teachings in the broadest sense, and are instead disclosed merely to describe particularly representative examples of the present disclosure.

In the description below, for purposes of explanation only, specific nomenclature is set forth to provide a thorough understanding of the system and method for providing additional information of related multimedia content. However, it will be apparent to one skilled in the art that these specific details are not required to practice the teachings of the current disclosure. Also other methods and systems may also be used.

### 1. Definitions

In the description herein, for descriptive purposes only:
a “first content” refers to a multimedia content provided to be viewed by a user through a user terminal;
a “second content” refers to a multimedia content other than a first content currently being provided to a user, and the second content may be a first content in another scenario for a different user and is defined only relative to a “first content”;
a “portion of interest” is a portion of the first content that is identified as of interest to a user and/or as potentially linked to a second content;
a “reference portion” is a part of a “portion of interest”, which is actually or potentially a basis for a link to a second content;
a “key reference” is a reference portion that is already set up as linked to a second content; and
a “learning data” refers to a collection of data on one or more second content provided to users as tentatively related to a specific same reference portion and user feedback to each of the provided second content, which may be dynamically updated and may involve a large number of users for the same reference portion.

### 2. Overview

A multimedia content may be linked to another multimedia content based on a portion of the content itself instead of other identifications like actors staring in the multimedia content, a producer of the multimedia content, or a performer, etc. For example, in many of the episodes/movies, an actor of a character may quote a dialogue of another character of another movie/episode or act (mimics or dresses) like another character from another movies/episode. For example, famous quoted dialogues may include:
[The Godfather]: “I’ll make him an offer he can’t refuse”;
[The Lord of the Rings]: “my precious”;
[Game of Thrones]: “winter is coming”.

Although such quoted dialog shown in a multimedia content other than the original content may create dramatic effects, a user might not fully appreciate such dramatic effect if the user has not watched the original shows/movies. Further, triggered by the somehow dramatic effects, a user may want to watch the original movie where such dramatic dialogues originated from. This current disclosure will allow the information of the original content be presented to the users either automatically or upon the users’ request in a technical advantageous solution.

The similar issue also exists for sports related content, e.g., live TV program on sports games, as well. For example, in a live TV program of a sports game, a sports commentator might refer to some existing records which have been broken through the current game, e.g. number of home runs of a player in a baseball season. This disclosure will allow the user to get the proper context or background information by showing the statistics of the original records, e.g., record holders and a highlight reel/video clip/textual summary of the earlier records. Such summary could be already available or be dynamically generated on the fly, e.g., by concatenating all his home run hits in one video clip.

For example, in a TV live of an NBA game, multiple records may be broken, e.g., at a first time point, commentator may announce “400 3-pointers by player XXX in a season” and at another time point, the commentator may announce “73 regular season wins”. Information about the other 3-pointers of the player or number of 3-pointers of another competing player may be of interest to the user.

In news broadcasting, reporting of a news event may quote some related event and other information may also be of interest to a user, e.g., detailed information on the news reported, news analysis, history of the relevant area, e.g. if multiple such incidents happened, statistics on previous times the event occurred, etc.

For a multimedia content of personal milestones, e.g. video clips of a birthday party or an anniversary ceremony, links may preferably be made to the related personal videos or images of other birthday party, anniversary celebration, and other person’s videos and images on the same event and/or information of attendee’s similar events, etc.

Using the present solution, a user will be provided with the context of the quote/record by, e.g., displaying a summary on the quote and if available, a short video snippet (from YouTube or any other streaming service) where the quote was originally used or a link for user to buy/watch the related episode/movie where the quote is originated from. This also enables user to have a better appreciation of the current multimedia content being consumed, along with the additional options to switch to watch the related original content.

It is appreciated that various content portions may be of interest to a user and may link a current content with another content. The term “content” may include anything that is expressed in some medium and provided to a user by a content distributor, which includes but not limited to video, audio, sill image, text content. The content is part of an actual program delivered to a user. It may be a streamed multimedia item, e.g., a YouTube video clip, accessed by a user through internet, sent over cable, or satellite broadcast. A “content portion” or “portion of content” refers to a portion of substantive information contained in a content as compared to meta data that include peripheral information related to a content. Such peripheral information may include a producer of the content or an actor of a character in the movie. For example, the content and a portion of the content of a movie includes a portion of the video expression of the movie itself and does not include meta data or peripheral information of the movie, like year of production, actor/actress names, etc. Of course, if information is actually presented in the video expression itself, such as the actor’s name is spoken or a year is stated, that is part of the content.

A portion of a content that links or to be linked to another content may be referred to as a “reference portion”. A reference portion may be a text string, a sound characteristic, e.g., a specific human voice characteristic, an action characteristic, e.g., a specific way of waving hands, or other content portions that links the two contents.

A first content provided to a user may be monitored either remotely, e.g., on the side of a content distributor, or locally through an application integrated in and/or attached to a local user terminal that receives and presents the content. A reference portion(s) may be identified from the monitored first content and second contents associated with the identified reference portion of the first content may be presented to the user in various means.

The association between a content and a reference portion may be predetermined and set up in a backend operation, e.g., manually or using historical data through big data analysis or other methods. Such predetermined association between a reference portion and a content may be stored in a database, in which the reference portion may be labelled as a key reference and linked to that content. Such key reference may then be embedded in a multimedia content itself, such as through a backend operation. For example, when the quote “my precious” is identified as a key reference associated with The Lord of the Rings, this key reference may be embedded to all the multimedia contents that include a phrase “my precious”. The embedment may be achieved via any approaches and all are included in the disclosure. For example, the key reference may be embedded as a metadata linked to the specific portion of the content data which includes the phrase “my precious”.

The embedment of the key reference to a content may make the linking operation to another content be conducted much faster. For example, when a portion of a first content or a reference portion therein is identified, the embedded metadata may be automatically obtained and the metadata may directly link to the associated second other contents. For the example of “my precious”, each time such phrase is presented in a first content or a portion of the first content, the embedded key reference, e.g., metadata, will automatically link it to The Lord of the Rings. In the case there is no embedded metadata, the identified reference portion may be mapped into the database storing the key references and associated (second) contents. If the identified reference portion maps into one or more key references in the database, the reference portion may then be linked to the related second contents that are associated with the mapped key references. And such related second contents or the information thereof may then be presented to the user.

Further, a reference portion contained in the presented first content may be lively or dynamically associated with a second other content using machine learning and based on learning data involving the reference portion. In a certain period of time, a specific first content, e.g., a TV episode, may be provided to thousands of users and for each reference portion identified in the TV episode, various tentatively “related” second contents may be presented to the thousands of users. Based on user feedback on the presented second contents, e.g., whether a user activates the presented second content, the list of second contents as tentatively related to the identified reference portion may be dynamically updated and enhanced. Such dynamic updating or learning of the association between identified reference portion and second contents may be customized for each user, user group, regions, and/or based on other criteria.

### 3. Example System

FIG. 1 illustrates an example operation environment 100 for providing additional information of related multimedia contents. In this example, environment 100 may include a content distributor 102, a content provider 104, an information provider 106, and a communication network 110. In some examples, content distributor 102 and content provider 104 may be integrated together or may be linked through a contractual arrangement in providing multimedia content to a user. At the meanwhile, a third party content distributor 108 may also be linked to a same or different content provider 104 in providing multimedia content to the same user, separately from content distributor 102.

Typically, content providers 104 generate, aggregate, and/or otherwise provide content that is provided to one or more users. Sometimes, content providers may be referred to as “channels” or “stations.” Examples of content providers 104 may include, but are not limited to: film studios; television studios; network broadcasting companies; independent content producers, such as AMC, HBO, Showtime, or the like; radio stations; or other entities that provide content for viewer consumption. A content provider 104 may also include individuals that capture personal or home videos and distribute these videos to others over various online media-sharing websites or other distribution mechanisms. The multimedia content provided by content providers 104 may be referred to as program content or “content”, which may include movies, sitcoms, reality shows, talk shows, game shows, documentaries, infomercials, news programs, sports programs, songs, audio tracks, albums, or the like. In this context, program content may also include commercials or other television or radio advertisements. It should be noted that the commercials may be added to the program content by content providers 104 and/or content distributor 102. Examples described herein generally refer to “content”, which includes any multimedia content including but not limited to audio content and visual content.

In some examples, content distributor 102 provides the content, e.g., obtained from content provider 104 and/or the data from information provider 106, to a user through a variety of distribution mechanisms. For example, in some embodiments, content distributor 102 may provide the content and data to a user’s user entertainment systems 124 (shown as 124A, 124B) directly through communication network 110. In other embodiments, the content may be sent through uplinks 112, 114, e.g., RF transmitting stations, which goes to satellite 130 and received through downlink station 128, e.g., a satellite receiver, connected to a user environment 120. The content is then sent to an individual user entertainment systems 124 (124A, 124B) of a user at user environment 120.

Third party content distributor 108 may be a content distributor different than content distributor 102 with respect to the service access arrangement/subscription with the user. For example, a user may subscribe to multiple satellite content distributors and or may be subscribed to different content distribution products, e.g., internet stream and satellite STB, of a same content distributor.

In user environment 120, a user may have multiple user entertainment systems 124 (124A, 124B shown for examples) which are capable of receiving multimedia contents provided by content distributor 102 and/or third party content distributor 108 through various means, e.g., network 110 and/or satellite 130 or other broadcasting means. User entertainment systems 124 may be any device that receives and presents the content from content distributor 102. Examples of user entertainment system 124 may include, but are not limited to, a set-top box, a cable connection box, a computer, a mobile device (e.g., a smart phone), a television receiver, a radio receiver, or other connected devices. User entertainment systems 124 may be configured to decode the content data and provide: (a) a visual component of the program content or other information to a user’s display device 126, such as a television, monitor, or other display device, and (b) an audio component of the program content to the television or other audio output devices. For descriptive purposes, user entertainment system 124 may be referred to as user terminal 124.

User terminals 124 may be integrated with display device 126 and/or may be communicatively coupled to display device 126.

Content monitor 122 may be located in user environment 120 and/or be located with information provider 106. Content monitor 122 may be configured to monitor a content presented by a user terminal 124 through display device 126. Content monitor 122, if located in user environment 120, may be communicatively coupled to information provider 106 through network 110 or other means. Content monitor 122 may be integrated into a user terminal 124 or may be a stand-alone device and may function as a plug-in device/application to achieve the functions of content monitoring. For example, content monitor 122 may be a device provided by content distributor 102 to a user in user environment 120, which may also be able to function as a plug-in application/device to monitor content displayed and received from third party content distributor 108 other than content distributor 102.

Information provider 106 may create and distribute data or other information that describes or supports content. Generally, such data may be related to the program content distributed by content provider 102 that is associated with information provider 106. For example, this data may include metadata, program name, closed-caption authoring and placement within the program content, timeslot data, pay-per-view and related data, or other information that is associated with the program content. In some embodiments, a content distributor 102 may combine or otherwise associate the data from information provider 106 and the program content received from content provider 104, which may be referred to as the distributed content or more generally as content. However, other entities may also combine or otherwise associate the program content and other data together.

More specifically, information provider 106 may coordinate with content monitor 122 in providing additional information of related second content based on the first content consumed by a user through a user terminal 124.

Communication network 110 may be configured to couple various computing devices to transmit content/data from one or more devices to one or more other devices. For example, communication network 110 may be the Internet, X.25 networks, or a series of smaller or private connected networks that carry the content. Communication network 110 may include one or more wired or wireless networks.

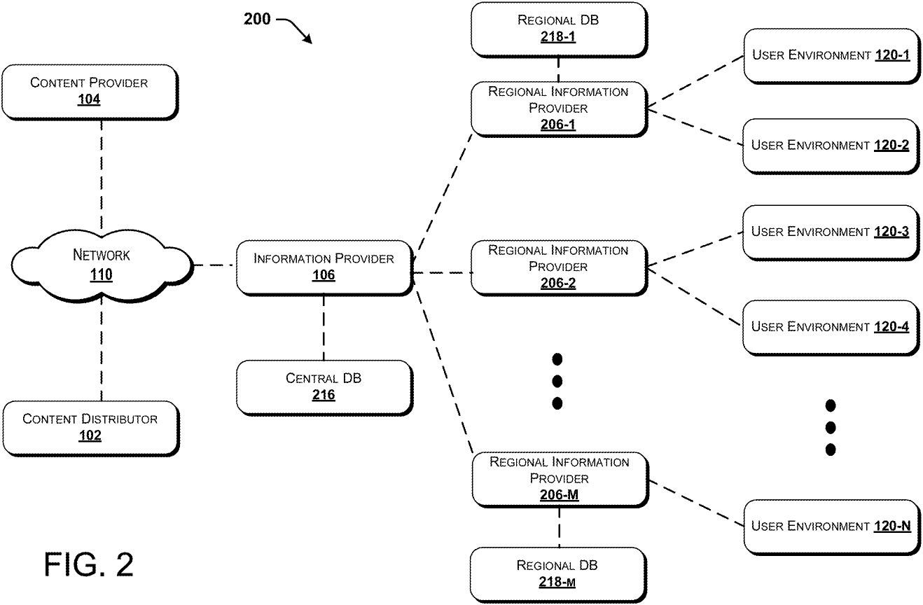

FIG. 2 illustrates an example distributed computing architecture 200. Referring to FIG. 2, architecture 200 may include multiple regional information providers 206 (206-1 ... 206-M, where M is an integral), each associated with multiple user environments 120 among all users environments 120 (120-1 ... 120N, where N is an integral). Regional information providers 206 (referred herein also as “regional server 206”) are also associated with and/or function together with one (or more) central information provider 106 (referred herein also as “central server 106”) in providing additional information of related second contents based on the first content currently provided to a user environment 120. Regional servers 206 and central server 106 may communicate with content distributor 102 and/or content provider 104 either individually or in coordinated manner.

In the description herein, the operations of central server 106 and regional servers 206 are described with content distributor 102 for illustrative purposes only. Central server 106 and regional servers 206 may also function together with third party content distributor 108.

As shown in FIG. 2, central server 106 may be communicatively coupled to one or more central database 216 and regional servers 206 may be each communicatively coupled to one or more regional databases 218 (218-1 ... 218-m, where m is an integral either equal to or different from M). Databases 216, 218 may reside locally with the corresponding servers 106, 206 or may be cloud based and communicatively coupled to the corresponding servers 106, 206 through network 110.

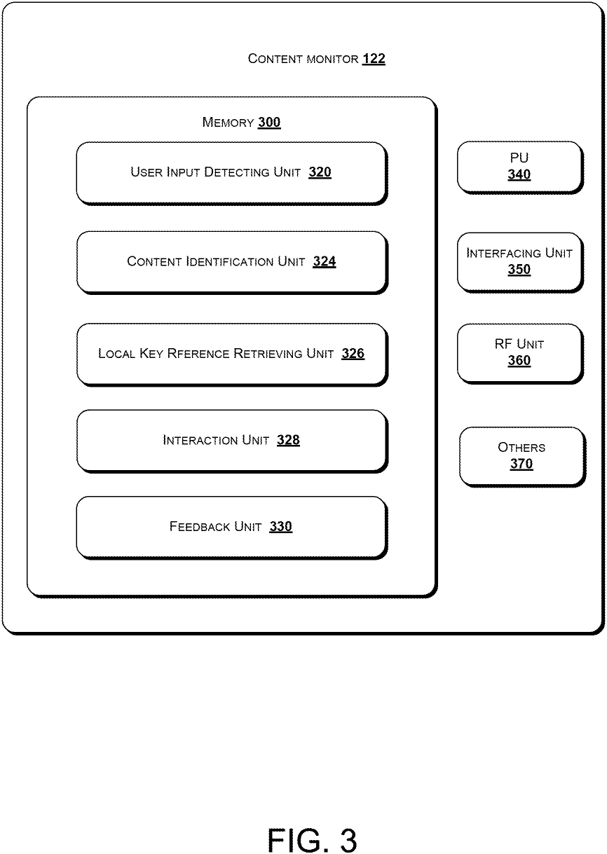

FIG. 3 is a system diagram of an example content monitor 122. As shown in FIG. 3, content monitor 122 may include a memory 300, which contains computer executable instructions which, when executed by a processing unit (e.g., a processor), may configure the processing unit to implement a user input detecting unit 320, a content identification unit 324, a local key reference retrieving unit 326, an interaction unit 328 and a feedback unit 330. Content monitor 122 may further include one or more processing unit (PU) 340, one or more interaction unit 350, one or more radio frequency (RF) unit 360 and other components 370.

User input detection unit 320 may be configured to detect a user reaction to a first content. User reactions may include various forms of active inputs including, but not limited to, voice command, gesture input, and/or other inputs through human machine interfaces like mouse, keyboard and/or remote controller. User reaction may also include various forms of passive reactions/ inputs like facial expression or change in facial expression and body positions or change in body position, which are not an active input but indicate user’s reaction to the first content or a portion of the first content. User input detection unit 320 may include various sensors, e.g., image sensors, motion sensors, to detect user’s passive reaction (input). User input detection unit 320 may be configured to detect and receive any form of user input and detect and identify that the user input is related to a specific portion of the first content currently present that is of interest to the user for potentially additional information of related contents.

Content identification unit 324 may be configured to detect an indication that a portion of the first content that is of interest to a user, referred to herein as a “portion of interest” for descriptive purposes. A portion of interest may be automatically detected by content identification unit 324 based on the monitored first content itself. For example, if a portion of the monitored first content presented to the user includes an embedded key reference, e.g., a metadata, such a portion of the first content may be automatically detected as a portion of interest. A portion of interest may also be identified based on detected user inputs. For example, the identified portion of interest may be based on a detected gesture of a user, e.g., a hovering finger circling a portion of the first content presented on the display screen of display device 126. In an example, content identification unit 324 may use a rule in identifying a portion of interest. A rule may stipulate that as much as possible information be included in the identified portion of interest to facilitate further processing of the portion of interest. A rule may also stipulate that only a complete sentence, a complete still image, or a complete action/movement be included in the portion of interest. Other rules in identifying a portion of interest may also be possible and included in the disclosure.

Local key reference retrieving unit 326 may be configured to locally retrieve embedded key reference, if any, from the identified portion of interest. The identified portion of interest may include embedded key reference, e.g., in the form of metadata. With the portion of interest locally identified, local key reference retrieving unit 326 may determine whether there is any embedded key reference embedded with the identified portion of interest. If any, such embedded key reference may be retrieved and provided to regional server 206 and/or central server 106. Such local retrieval of the key references may have the technical advantage of speedy processing and reaction. However, on the other side, local retrieval may be limited to that the monitored content is provided by content distributor 102 that is associated with content monitor 122. For a content provided by third party content distributor 108, local key reference retrieving unit 326 may not be able to retrieve the key references embedded in the identified portion of interest.

Interaction unit 328 may be configured to interact with a user with respect to providing additional information of related second content based on the first content presented to the user. For example, interaction unit 328 may inquire with the user regarding whether the provided additional information meets the user’s needs. Interaction unit 328 may then receive the user’s feedback and communicate with other components of content monitor 122, regional server 206 and/or central server 106 regarding the user’s feedback. Interaction unit 328 may also function without a user’s active involvement. For example, interaction unit 328 may collect user reactions without disturbing user’s experience on consuming the first content. For example, interaction unit 328 may collect user’s actual reaction to the provided additional information such as whether a user activates the link to the related second content and/or whether the user further requests additional information.

Feedback unit 330 may be configured to feedback the user’s reactions to the provided additional information of the related second content to regional server 206 and/or central server 106.

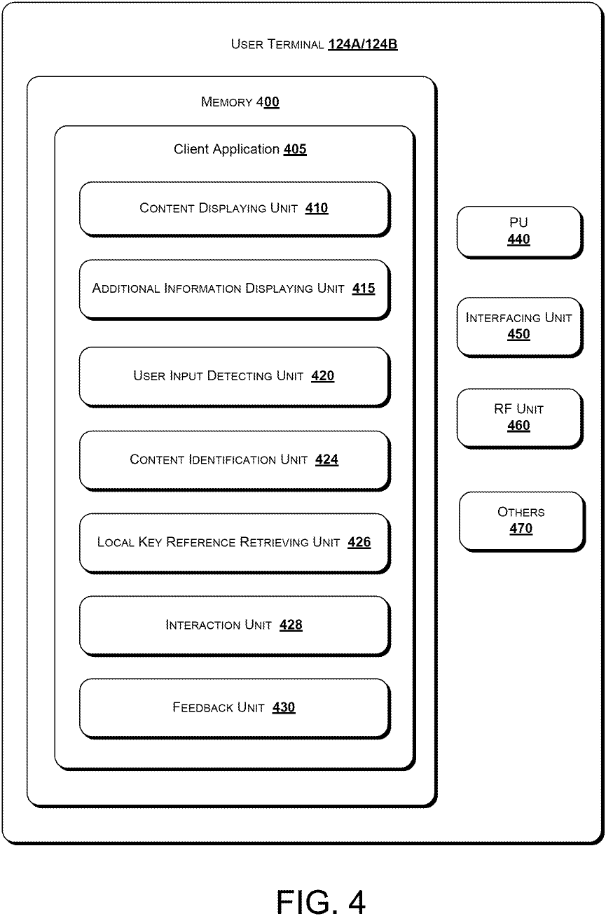

FIG. 4 illustrates an example user terminal 124. As shown in FIG. 4, user terminal 124 may include a memory 400 which stores computer executable instructions which, when executed by a processing unit, may configure the processing unit to implement a client application 405. Client application 405 may have content monitor 122 integrated therein. For example, user input detection unit 420, content identification unit 424, local key reference retrieving unit 426, interaction unit 428 and feedback unit 430 of client application 405 may include similar functions and structures as user input detection unit 320, content identification unit 324, local key reference retrieving unit 326, interaction unit 328 and feedback unit 330 of content monitor 122.

Further, client application 405 may include a content display unit 410. Content display unit 410 may receive a first content from a content distributor, such as content distributor 102 described above, and present the received first content to be displayed through display device 126.

Client application 405 may also include an additional information displaying unit 415. Additional information displaying unit 415 may be configured to receive additional information of a related second content from regional server 206 and/or central server 106, and present the information of the second content to be displayed through display device 126. It should be appreciated that additional information displaying unit 415 may or may not function together with content displaying unit 410. It is possible that content displaying unit 410 does not present a first content to be displayed and the first content is displayed by another content distributor, e.g., third party content distributor 108. Based on the monitored content of a third party distributor, additional information displaying unit 415 my present additional information of related second content.

User terminal 124 may also include one or more processing unit (PU) 440, one or more interfacing unit 450, one or more radio frequency (RF) unit 460, and other components 470.

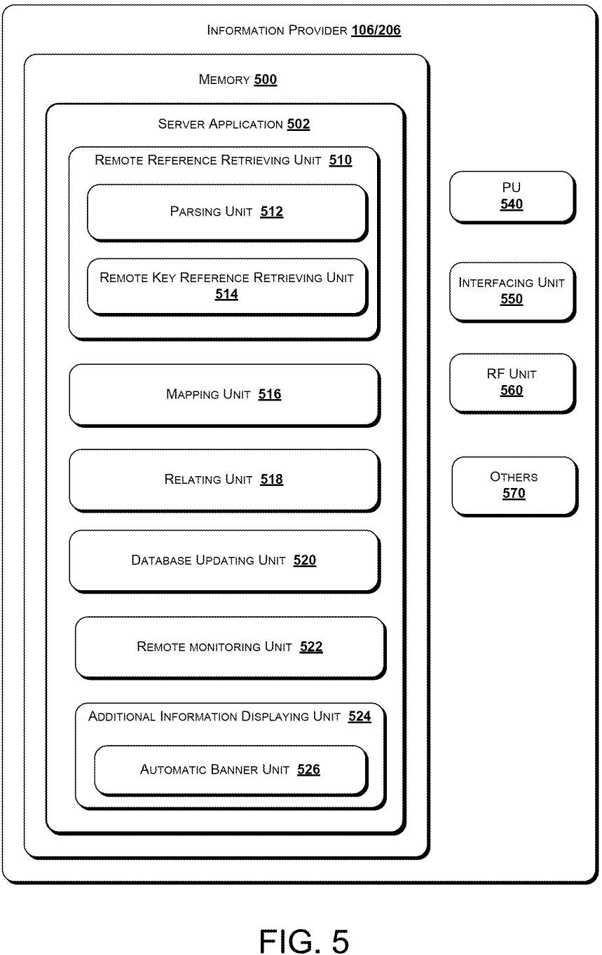

FIG. 5 illustrates an example information provider server. The example server of FIG. 5 may be either a regional server 206 or a central server 106. As shown in FIG. 5, information provider 106/206 may include a memory 500 that stores computer executable instructions which, when executed by a processing unit, configure the processing unit to implement a server application 502. Server application 502 may include a remote reference retrieving unit 510, a mapping unit 516, a relating unit 518, a database updating unit 520, a remote monitoring unit 522 and an additional information presenting unit 524. Remote reference retrieving unit 510 may further include a parsing unit 512 and a remote key reference retrieving unit 514. Additional information presenting unit 524 may further include an automatic banner unit 526.

Information provider 106/206 may also include one or more processing unit (PU) 540, one or more interfacing unit 550, one or more radio frequency (RF) unit 560, and other components 570.

Remote reference retrieving unit 510 may be configured to receive information on a portion of interest identified at user environment 120 by user terminal 124 and/or content monitor 122, and to retrieve a reference portion(s) from the received portion of interest.

Remote reference retrieving unit 510 may also be configured to automatically retrieving additional information of related second content from a first content distributed and provided to a user environment 120 through content distributor 102. For example, remote key reference retrieving unit 514 may function together with remote monitoring unit 522 to lively monitor a first content provided to a user environment 120 via a user terminal 124, and to automatically retrieve key references embedded in the first content being presented. The retrieved key references may already be linked to one or more second contents through back-end operations such that the automatic retrieval of the key reference practically makes the additional information of the related second content ready to be presented to a user in user environment 120.

Specifically, parsing unit 512 may be configured to parse the receive portion of interest to obtain one or more reference portions. The parsing may be based on any known approaches and may be based on the categories of key references created in the back-end operations. For example, the parsing may be based on whether a complete sentence is spoken, a complete movement is conducted or a complete image is presented. The parsing may also be based on whether a sound characteristic is similar to another sound characteristic. Background characteristics, such as background image and background music, may also be used in the parsing.

In an example, parsing unit 512 may parse a received portion of interest using at least one of the audio portion, the image portion or the text portion of the portion of interest in the parsing. For both the text portion, e.g., the subtitles contained in the portion of interest, and the audio portion, parsing unit 512 may extract a text based reference portion(s), namely, a reference portion of a text string. For a text portion, parsing unit 512 may extract text a text string through analyzing the text portion using an included text processing module (details not shown for simplicity). For example, the text processing module may extract reference portions based on one or more of a complete sentence or a complete phrase contained in the text portion.

An audio processing module (details not shown for simplicity) of parsing unit 512 may process the audio portion following two steps. In step one, audio processing module may separate sound characteristic, e.g., the audio pitch information, from text content of the audio portion. The sound characteristic information may then be separately processed to obtain an audio based reference portion(s). For example, every human’s speech has a unique sound characteristic/ signature, such as, the speed and the audio pitch. Such sound signature may be used to link a first content to a second content.

In step two, the separated text content of the audio portion may be converted to a text string and then processed by the text processing module to obtain text based reference portions. Any and all audio to text converting solutions may be used and all are included.

It should be appreciated that in the case that the text content of the audio portion is not successfully converted to a text string, the sound characteristic of the audio portion itself will be processed to obtain a reference portion.

Further, as a specific example of an audio portion, a song or sound tracks included in a background and/or foreground of a motion picture content, e.g., a movie or a TV episode may itself by used a reference portion. Information about soundtracks that are part of a movie/TV show is usually easily available, and this information can be manually embedded by an operator into the first content. Some songs have become clear identifiers of the related motion picture contents. For example, “Live and Let Die” by Paul McCartney was part of the soundtrack of the Bond movie of the same name. “Extreme Ways” by Moby was part of the soundtrack for the Bourne movies.

For the image portion, an image processing module (details not shown for simplicity) of parsing unit 512 may be configured to identify image related reference portions, including both still image and/or moving/video image. For example, a specific pattern of movement may be identified as an image based reference portion. A specific background image, e.g., a famous landmark building, may also be identified as an image based reference portion.

Further, image processing module of parsing unit 512 may also analyze the image portions to help in the extraction of the text based reference portion and the audio based reference portion, which may reduce the search range, resulting in faster search of the text based reference portions. For example, if a character is dressed like a wizard, such as pointy hat and staff/wand, in a first content, such image information, namely, image based reference portion, may help to extract a quote that originated from a wizard movie, e.g., The Lord of the Rings, Harry Potter etc.

As described herein, parsing unit 512 may obtain multiple reference portions in multiple different categories from a received portion of interest. Such multiple reference portions may be used separately or in various combinations in obtaining related second contents.

Mapping unit 516 may be configured to map an obtained reference portion with a database of key references. The database may associate key references with second contents. If an obtained reference portion maps with a key reference, the reference portion may then be linked to the contents associated with the key references. In an example, the mapping may use a tiered mapping criteria. Under the tiered mapping criteria, an obtained reference portion may be first mapped with the key references using a higher criterion, e.g., 100% matching. If a match is found using the higher criterion, the mapped key reference may have the priority of being used to link and/or present the related contents. After the higher criterion is used for the mapping, the reference portion may be mapped into the database of key references under a lower criterion, e.g., 85% matching. The mapping under the lower criterion may generate more key references besides the key references generated under the higher mapping criterion, if any. Such additional key references and the associated contents may have a lower priority of being used to link and/or present the respective related second contents.

Relating unit 518 may be configured to relate a retrieved reference portion with another content using learning data. Learning data may include lively updated historical data indicating an association of the reference with one or more second contents. In an example, the historical data include user reactions to the presented additional information of related second contents as linked to the reference portion. Such learning data may help the identification and presenting of additional information of related second content in at least two ways. First, such learning data may help update the priority list of the mapped key references and the related second contents. For example, in a sports games, if a commentator yells “record broken”, both the term “record” indicating a record in the sports game, the quote “record broken”, and the specific voice signature of the commentator in saying “record broken” may be extracted as reference portions, and the three example reference portions may map into different key references and the associated different second contents. Learning data may indicates, for example, based on thousands of feedbacks from users toward the presented related second contents, that users are more interested in the second contents linked to the specific voice signature of the commentator which actually mimics another famous sports commentator in the past. With such learning data analysis, relating unit 518 may relates the portion of interest, i.e., the commentator yelling “record broken,” more to the second contents that originate the specific voice signature by the other famous sport commentator in the past.

Secondly, in the scenario that the mapping does not yield reliable results, relating unit 518 may use the learning data to dynamically relate the obtained reference portion(s) to second contents. For example, when a mapping of a reference portion into the database of key references does not generate a match, i.e., no matching threshold is met, the otherwise possible key references and the associated second contents may be presented to a user as a tentative/learning relationship and the user’s feedback may be collected to refine the learning/tentative relationship. Such learning relationship may be greatly refined if the same reference portion and the learning relationship are presented to a large number of users and feedback/reactions of the large number of users are received.

Relating unit 518 may function together with interaction unit 428 of user terminal 124.

Database updating unit 520 may be configured to update database based on the results of the operation of relating unit 518. In an example, database updating unit 520 may update two separate databases or two separate portions of a same database. One database may save the learning data, e.g., the learning relationship and the user feedback on the learning relationship. As the learning relationship and the user feedback may be dynamically updated, this database may be referred to as a “transient database” for descriptive purposes. Another database may save the key references and the association with second contents, which may be referred to as a “permanent database” for descriptive purposes.

Different criteria may be setup for a learning relationship between a reference portion and a second content to enter the transient database and the permanent database. In an example, lower criteria, e.g., lower number of positive user feedback on a related second content presented to users based on a learning relationship, may be set up for a learning relationship to enter the transient database and much higher criteria may be set up for a learning relationship to enter the permanent database. Further, manual review of the learning relationship may be required for the learning relationship to enter the permanent database.

Remote monitoring unit 522 may be configured to monitor a first content presented to a user environment 120 through a user terminal 124 on the server side. As content distributor 102 is linked to information provider 106/206, such remote monitoring of the content presentation is possible. For a first content provided to a user by third party content distributor 108, remote monitoring unit 522 may not be able to monitor the content on the server side and content monitor 122 and/or user terminal 124 in the user environment 120 may be used to locally monitor the first content presented to the user.

Additional information presenting unit 514 may be configured to function together with content distributor 102 to present the additional information of related second content with the first content currently being presented. For example, additional information presenting unit 514 may communicate to content distributor 102 with respect to a list of related second content and the priority level of each related second content. Depending on the display space reserved for such additional information, additional information presenting unit 514 may control the manner of presenting the additional information. For example, additional information presenting unit 514 may control to present only the additional information fit into the reserved display space based on the priority of the related second content. Additional information presenting unit 514 may also control to rotate the displaying of the additional information.

Additional information presenting unit 514 may also control what information to be presented for the related second content. Identification of the related second content may always be included. Other information of the related second content, e.g., year of production, stars, producers, etc. may be presented. A video clip of the related second content may also be presented. The choice of related video clip could also be individualized and depend on the age profile of the user and/or parental control settings for the user. This would ensure age appropriate content is shown.

Automatic banner unit 526 may be configured to automatically present additional information of related second content along with the first content being presented.

It should be appreciated that although elements of content monitor 122, user terminal 125 and information provider 106/206 are described as belonging to the specific relevant server/ device, such examples are not limiting. Some or all functions of a user side device, e.g., content monitor 122 and user terminal 124, may be achieved through a server 106/206 in coordination with a local user terminal. Some or all function of a server 106/206 may also be achieved through a local connected device, e.g., user terminal 124 or content monitor 122, as long as the local CPU and memory include sufficient capacity.

### 4. Example Methods

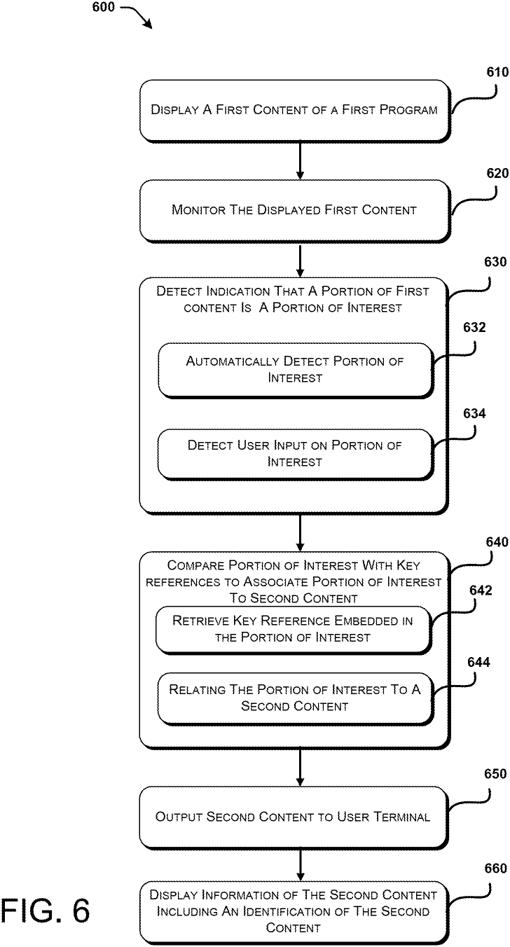

FIG. 6 illustrates an example operation process. In the description of operation process 600, examples are taken that the first content of the first program is presented by content distributor 102 related to information provider 106. It should be appreciated that the operation process 600 may also apply to the scenario that a first content of a first program is provided by a third party content distributor 108. Further the operations at user environment 120 will be described using an example user terminal 124. It should be appreciated that similar operations may be conducted by a stand-alone content monitor 122 as described herein.

In example operation 610, content displaying unit 410 of user terminal 124, e.g., user terminal 124A, may display a first content of a first program received from content distributor 102.

In example operation 620, remote monitoring unit 522 of regional server 206 and/or central server 106 may monitor the displayed first content. For example, the remote monitoring may automatically identify the embedded key references in the displayed first content. The identified embedded key references are associated with related second contents based on back-end operations. Whether information of such related second contents is automatically presented to the user may be chosen by the user in program setting of user terminal 124 and/or through user interaction.

Local user terminal 124 and/or content monitor 122 may also monitor the presented first content.

In example operation 630, content identification unit 424 may detect an indication that a portion of the first content is a portion of interest. The indication detection may include two sub-operations. In sub-operation 632, content identification unit 424 may automatically detect portion of interest based on embedded key reference. For example, when the displayed first content includes an embedded key reference, content identification unit 424 may detect the embedded key reference and automatically identify the relevant portion of first content as a portion of interest and the embedded key reference may be retrieved for potential further processing. For example, the retrieved key references may be automatically transmitted to additional information presenting unit 524 to make it ready to retrieve the associated second content. Such automatic identification of portion of interest may help reduce response time.

In sub-operation 634, content identification unit 424 may identify a portion of interest based on a detected user reaction to the presented first content. For example, the user reaction (input) may be detected by user input detection unit 420 and received by content identification unit 424. The user reaction may be an active input, i.e., the user actively makes an input through, e.g., voice command, gesture, or remote control of user terminal 124. The user input may also be a passive input, namely, the user does not make any active input but user input detection unit 420 may detects, e.g., through user’s facial expression or body movements, that the user is interested in a portion of the content for further information.

Content identification unit 424 may identify the portion of interest based on various criteria, e.g., timing relevancy and content relevancy. In an example, content identification unit 424 may choose to err on the thoroughness side in identifying the portion of interest to facilitate further processing.

In example operation 640, the identified portion of interest may be compared with key references stored in a database to associate the portion of interest with one or more second content. The comparing of a portion interest with a key reference may include any approaches to analyze the portion of interest with respect to the key reference.

In sub-operation 642, local key reference retrieving unit 426 and/or remote key reference retrieving unit 514 may retrieve embedded key reference from the identified portion of interest. Local key reference retrieving unit 426 may be able to do relatively simple processing to retrieve the embedded key reference. For example, if the portion of interest includes only a small number of embedded key references, it might be satisfactorily processed by the local key reference retrieving unit 426 to reduce reaction time. If the identified portion of interest is relatively complicated, e.g., including multiple reference portions of various categories of text, audio, and image reference portions, local key reference retrieving unit 426 may not have the sufficient CPU and memory resources to satisfactorily process it and remote key reference retrieving unit 514 may further retrieve the embedded key references from the portion of interest.

In sub-operation 644, alternative and additional to retrieving embedded key reference, the portion of interest may be related to a second content. If a key reference is retrieved, the relating may be based on the key reference, which is already associated with a second content due to back-end operation. If no key reference has been retrieved from the portion of interest, further operation may be conducted to relate the portion of interest with a second content.

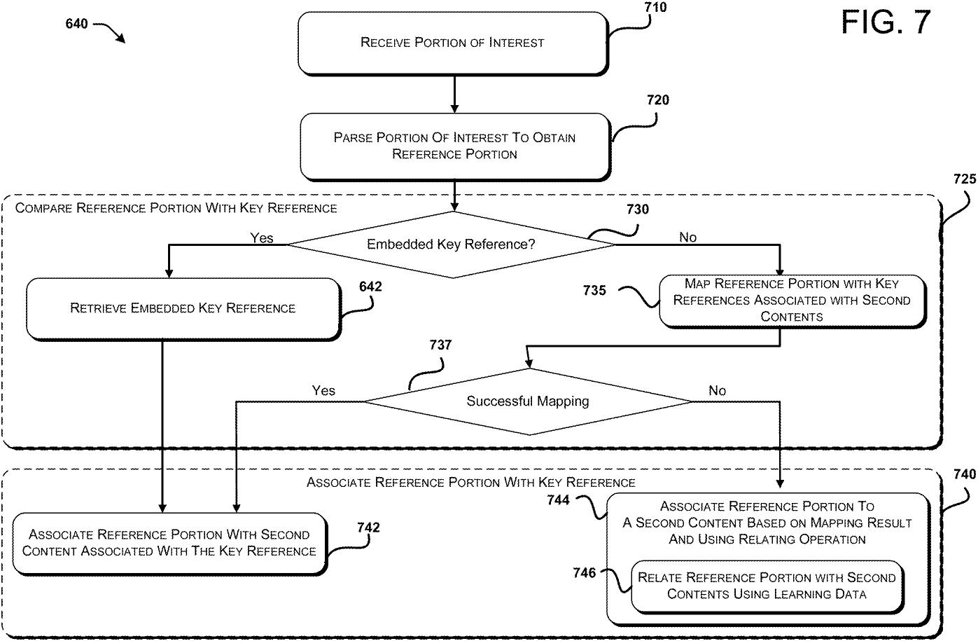

FIG. 7 illustrates example details of operation 640 on the server side. Referring to FIG. 7, in operation 710, information provider 106/206 may receive an identified portion of interest from user terminal 124.

In operation 720, parsing unit 512 may parse the received portion of interest to obtain reference portions. The reference portions may include various categories such as text based reference portion, audio based reference portion or image based reference portion. In an example, the parsing may be at least partially based on whether a key reference is embedded in a part of the portion of interest. Further, the parsing may not remove an embedded key reference, if any.

In example operation cluster 725 (referred to with a dotted block), each reference portion may be compared with key references associated with second contents to associate the each reference portion with a second content.

In example operation cluster 740 (referred to with a dotted block), a reference portion is associated with a second content based on a result of the comparing.

Specifically, in example operation 730, determination made be made by remote key reference retrieving unit 514 with respect to whether an obtained reference portion includes an embedded key reference. If an embedded key reference exists for the reference portion, in example operation 642, remote key reference retrieving unit 514 may retrieve the embedded key reference which may be used to directly obtain the associated second content.

In example operation 742, the reference portion is associated with the second content that is associated with the embedded key reference in the database.

If a reference portion does not include an embedded key reference, in example operation 735, mapping unit 516 may map a reference portion with the permanent database storing key references and the associated second contents. Normally, because the reference portion is dynamically/lively obtained through parsing of the portion of interest, a 100% match with the stored key reference may not need to be sought after. A balancing threshold may be used in the mapping. For illustrative example, an 80% matching may be set up as a threshold for the mapping operation. If a reference portion can be 80% mapped into a key reference in the permanent database, “yes” in operation 737, mapping unit 516 may treat the mapping as successful and reliable and the mapped key reference may be used to obtain the related second content in example operation 742.

If the mapping of a reference portion into the key references is not successful, i.e., no matching meets the threshold in example operation 737, in example operation 744, the reference portion may be associated with a second content using a relating operation.

Specifically, in sub-operation 746, relating unit 518 may relate the reference portion with a second content using learning data. Specifically, a result of the mapping, even if not meeting the matching threshold, e.g., a list of second contents based on a list of key references marginally matching the reference portion, may be presented to the user as tentatively related to the reference portion, i.e., a learning relationship, and user reactions may be collected by interaction unit 428 and feedback unit 430 of user terminal 124. Such user reactions may be used to fine tune the learning relationship between the reference portion and second contents. With learning data of the same reference portion from a large number of users, relating unit 518 may be able to tentatively establish an association between the reference portion and a second content. As the first content of the first program may be concurrently viewed by a very big number of users at a same time, relating unit 518 may be dynamically and lively establish an association between the reference portion and a second content.

Referring back to FIG. 6, in example operation 650,

In example operation 650, the additional information presenting unit 524 of information provider (regional server or central server) 106/206 may output the associated second content to user terminal 124 at least one of directly or through content distributor 102.

In example operation 660, additional information displaying unit 415 of user terminal 124 may display the information of the related second content, including an identification of the second content, for viewing by the user. Here additional information presenting unit 524 may provide the list of related second contents to content distributor 102 to be sent to user terminal 124. Additional information displaying unit 415 may locally control the manner that the additional information of the second content is presented. Upon user’s choice, content displaying unit 410 may switch to display the second content for viewing by the user.

It should be appreciated that it is not necessary that the additional information of the related second content be presented and display through a same user terminal as the one that displays the first content of the first program. For example, when the first content of the first program is displayed through user terminal A, 124A, such as a TV set, additional information displaying unit 415 may control to have the additional information of the related second content be presented and displayed in another connected device of the user, user terminal B, 124B, such as a smart phone, so that the user’s experience in consuming the first content will not be disturbed.

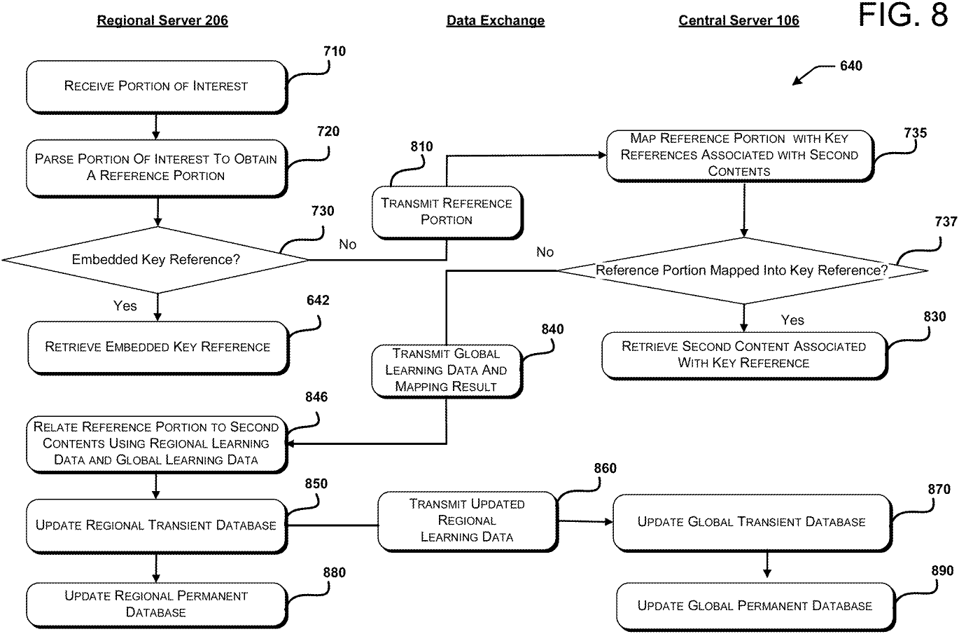

FIG. 8 illustrates an example operation process of a distributed computing scheme among regional servers 206 and central server(s) 106. Referring to FIG. 8, in example operation 710, portion of interest identified by user terminal 124 may be received at a regional server 206. In the description of FIG. 8, same referral number may be used for elements in both central server 106 and/or regional server 206.

In example operation 720, at regional server 206, parsing unit 512 may parse the received portion of interest to obtain reference portions.

In example operation 730, at regional server 206, remote key reference retrieving unit 514 may determine whether a key reference is embedded in an obtain reference portion.

In example operation 642, at regional server 206, if a key reference is embedded in the reference portion, remote key reference retrieving unit 514 may retrieve the embedded key reference.

If the reference portion does not include an embedded key reference, the reference portion may be, in example operation 810, transmitted to central server 106.

In example operation 735, at central server 106, mapping unit 516 may map the received reference portion with key references stored in a global permanent database of key reference and associated second contents.

It should be appreciated that alternatively or additionally, at regional server 206, mapping unit 516 may also map the reference portion with key references stored in a regional permanent database of key reference and associated second contents.

In example operation 737, at central server 106, it is determined whether a satisfactory mapping is obtained, e.g., a match threshold is met.

If a satisfactory mapping is obtained, in example operation 830, at central server 106, the mapped key reference may be used to retrieve the related second content.

If a satisfactory mapping is not obtained, in example operation 840, the mapping results (e.g., the marginally mapped key references and the related second contents) and a global learning data associated with the reference portion, if any, may be transmitted back to the regional server 206. For example the global learning data may include regional learning data from other regional servers 206. Due to time zone differences, a same first content may be distributed to users in different time zones and the relevant regional server 206 may already collect large pool of learning data relating the reference portion to second contents. The global learning data may be stored on central database 216 and the regional learning data may be stored on regional database 218.

In example operation 846, at regional server 206, relating unit 518 may relate the reference portion with second content using the mapping results, the global learning data, if any, and the regional learning data of user terminals 124 covered by regional server 206.

In example operation 850, at regional server 206, database updating unit 520 may update the regional transient database of the regional learning data based on the relating operation of operation 846.

In example operation 860, the updated regional learning data may be transmitted to central server 106 for the database updating unit 520 of central server 106 to update the central transient database of global learning data, in example operation 870.

In example operation 880, at regional server 206, when the regional learning data of a reference portion meets a threshold, e.g., a threshold number of user positive reactions on the provided second content is met, the learning data may be used to update the regional permanent database.

In example operation 890, at central server 106, when the global learning data of a reference portion meets a threshold, e.g., a threshold number of user positive reactions on the provided second content is met, the global learning data may be used to update the global permanent database.

These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described exemplary embodiments, but should be defined only in accordance with the following claims and their equivalents.

1-24. (canceled)

25. A method, comprising:
presenting first content to a user;
detecting a user interaction with the first content while the first content is being presented to the user;
identifying a portion of the first content associated with the user interaction;
determining a key reference associated with the identified portion of the first content;
selecting second content that is uniquely identified by the key reference, wherein the second content is different from the first content; and
presenting the second content to the user.

26. The method of claim 25, wherein selecting the second content comprises:
accessing a database of a plurality of key references using the key reference to obtain a link to the second content.

27. The method of claim 25, wherein determining the key reference comprises:
obtaining the key reference from metadata embedded within the first content and associated with the identified portion.

28. The method of claim 25, wherein determining the key reference comprises:
accessing a database of a plurality of key references using the identified portion to obtain the key reference.

29. The method of claim 25, wherein determining the key reference comprises:
analyzing the first content to extract text associated with the identified portion of the first content;
generating a reference portion from the extracted text; and
selecting the key reference from a plurality of key references based on the reference portion.

30. The method of claim 25, wherein determining the key reference comprises:
analyzing the first content to identify at least one image associated with the identified portion of the first content;
generating a reference portion from the at least one image; and
selecting the key reference from a plurality of key references based on the reference portion.

31. The method of claim 25, wherein determining the key reference comprises:
identifying a plurality of key references associated with the identified portion of the first content;
ranking the plurality of key references; and
selecting the key reference as a highest ranking key reference of the plurality of key references.

32. The method of claim 25, further comprising:
receiving feedback from the user regarding the second content; and
modifying the key reference to uniquely identify third content that is different from the second content.

33. The method of claim 25, further comprising:
receiving feedback from the user regarding the second content; and
dynamically modifying the first content to link the key reference to third content that is different from the second content.

34. The method of claim 25, further comprising:
modifying the key reference to uniquely identify third content based on feedback from the user regarding the second content; and
after the key reference has been modified:
presenting the first content to a second user;
detecting a second user interaction with the first content while the first content is being presented to the second user;
determining that the second user interacted with the portion of the first content associated with the key reference;
selecting the third content from the key reference; and
presenting the third content to the second user.

35. A computing device, comprising:
a memory configured to store computing instructions; and
a processor configured to execute the computing instructions to:
obtain first content;
present first content to a user;
detect a user interaction with the first content while the first content is being presented to the user;
identify a portion of the first content associated with the user interaction;
determine a key reference associated with the identified portion of the first content;
obtain second content that is uniquely identified by the key reference, wherein the second content is different from the first content; and
present the second content to the user.

36. The computing device of claim 35, wherein the processor obtains the second content by being configured to further execute the computing instructions to:
access a database of a plurality of key references using the key reference to obtain a link to the second content.

37. The computing device of claim 35, wherein the processor determines the key reference by being configured to further execute the computing instructions to:
obtain the key reference from metadata embedded within the first content and associated with the identified portion.

38. The computing device of claim 35, wherein the processor determines the key reference by being configured to further execute the computing instructions to:
analyze the first content to extract text associated with the identified portion of the first content;
generate a reference portion from the extracted text; and
select the key reference from a plurality of key references based on the reference portion.

39. The computing device of claim 35, wherein the processor determines the key reference by being configured to further execute the computing instructions to:
analyze the first content to identify at least one image associated with the identified portion of the first content;
generate a reference portion from the at least one image; and
select the key reference from a plurality of key references based on the reference portion.

40. The computing device of claim 35, wherein the processor determines the key reference by being configured to further execute the computing instructions to:
identify a plurality of key references associated with the identified portion of the first content;
rank the plurality of key references; and
select the key reference as a highest ranking key reference of the plurality of key references.

41. The computing device of claim 35, wherein the processor is configured to further execute the computing instructions to:
receive feedback from the user regarding the second content; and
modify the key reference to uniquely identify third content that is different from the second content.

42. The computing device of claim 35, wherein the processor is configured to further execute the computing instructions to:
modify the key reference to uniquely identify third content based on feedback from the user regarding the second content; and
after the key reference has been modified:
present the first content to a second user;
detect a second user interaction with the first content while the first content is being presented to the second user;
determine that the second user interacted with the portion of the first content associated with the key reference;
select the third content from the key reference; and
present the third content to the second user.

43. A system, comprising:
a remote monitoring unit configured to detect a user interaction with first content while the first content is being presented to a user;
a reference retrieving unit configured to identify a portion of the first content associated with the user interaction;
a mapping unit configured to determine a key reference associated with the identified portion of the first content and to select second content that is uniquely identified by the key reference, wherein the second content is different from the first content; and
a presenting unit configured to present information regarding the second content to the user.

44. The system of claim 43, further comprising:
a parsing unit configured to analyze the first content to extract text or images associated with the identified portion of the first content and to generate a reference portion from the extracted text or images; and
wherein the mapping unit is configured to map the reference portion to the key reference.
